(19) United States
(12) Patent Application Publication
(10) Pub. No.: US 2024/0044721 A1
(43) Pub. Date: Feb. 8, 2024

(54) Temperature Measuring Circuit

(71) Applicant: Analog Bits, Inc., Sunnyvale, CA (US)

(72) Inventors: Mohammad Mahdi Ahmadi, Tehran (IR); Alan C. Rogers, Palo Alto, CA (US); Jitendrakumar B. Thummar, Sunnyvale, CA (US)

(73) Assignee: Analog Bits, Inc., Sunnyvale, CA (US)

(21) Appl. No.: 17/882,540

(22) Filed: Aug. 6, 2022

(51) Int. Cl. G01K 7/34

(52) U.S. Cl. CPC G01K 7/34

(57) ABSTRACT

A temperature measuring circuit uses a diode to drain a switched capacitor at two different lengths of time. The capacitor's voltage is amplified, measured, and compared for each length of time to calculate a temperature. The circuitry may cancel out errors due to manufacturing tolerances and variations, as well as offset voltages, supply noise, substrate noise, and other issues. The process may charge a capacitor, then drain the capacitor with a diode for a first period of time, at which point, the diode is switched out of the circuit. The remaining charge in the diode may be amplified, then analyzed using an analog to digital converter. A second measurement may be taken with a different period of time, and the two measurements may be subtracted to yield an absolute temperature.

### BACKGROUND

Electronic devices, from large computers to cellular telephones, generate heat, and managing heat is an increasingly complex process, especially as processors are miniaturized.

Accurate temperature measurements are used to route workloads on a die, such as moving energy intensive workloads to circuitry that is cooler than other portions of a die that are already near their thermal operating limit.

Conventional temperature measuring circuits use parasitic PNP transistors as a temperature sensing element. However, in some fabrication technologies, the quality of temperature sensing using such transistors may degrade considerably due to manufacturing side-effects such as micro-defects in junctions in the PNP transistors. This phenomenon has caused these circuits to degrade, often creating errors as large as +/−8° C.

To compensate for these large errors in temperature sensing, manufacturers of integrated circuits usually use single- or multi-point circuit trimming to reduce the error below +/−5° C. The trimming process is time consuming and increases the manufacturing cost. Moreover, some fabrication processes may not offer parasitic PNP transistors.

### SUMMARY

A temperature measuring circuit uses a diode to drain a capacitor at two different lengths of time. The capacitor's voltage is amplified, measured, and compared for each length of time to calculate a temperature. The circuitry may cancel out errors due to manufacturing tolerances and variations, as well as offset voltages, supply noise, substrate noise, and other issues. The process may charge a capacitor, then drain the capacitor with a diode for a first period of time, at which point, the diode is switched out of the circuit. The remaining charge on the capacitor may be amplified, then analyzed using an analog to digital converter. A second measurement may be taken with a different period of time, and the two measurements may be subtracted to yield an absolute temperature.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a graphical illustration of an example analysis showing the temperature variation of a diode discharging a capacitor.

FIG. 2A is a schematic illustration of a first circuit for absolute temperature measurement.

FIG. 2B is a schematic illustration of a timeline for operating the circuit of FIG. 2A.

FIG. 3A is a schematic illustration of a second circuit for absolute temperature measurement.

FIG. 3B is a schematic illustration of a timeline for operating the circuit of FIG. 3A.

FIG. 4A is a schematic illustration of a third circuit for absolute temperature measurement.

FIG. 4B is a schematic illustration of a timeline for operating the circuit of FIG. 4A.

FIG. 5A is a graphical illustration of an example analysis showing a digital value generated during a temperature measurement where N=110 cycles.

FIG. 5B is a graphical illustration of an example analysis showing a digital value generated during a temperature measurement where N=12 cycles.

FIG. 5C is a graphical illustration of an example analysis showing a digital value generated using Dout=Dout1−Dout2.

### DETAILED DESCRIPTION

### Switched Capacitor Based Temperature Sensor Circuit

A switched capacitor temperature sensor circuit may charge a capacitor, and then discharge it through a diode for a predetermined period of time. The resulting voltage on the capacitor may then be measured using an amplifier and an analog to digital converter. By taking two measurements at two different predetermined periods of time, and calculating the temperature from the difference of the two measurements, many manufacturing and operational noise may be eliminated, yielding an accurate absolute temperature measurement.

The switched capacitor-based temperature sensor circuit may be used in a single capacitor circuit, where two measurements are taken consecutively, or may be implemented in a two-capacitor circuit, where the two measurements are taken simultaneously using a differential amplifier.

It has been shown that if a capacitor is charged to an initial voltage larger than the built-in junction potential of a diode and then being discharge by that diode, after a short initial transient time which is usually in the range of nanoseconds, the capacitor voltage may be calculated from

$${V}_{C} ( t ) = - η {V}_{T} ln ( \frac{{I}_{s}}{C η {V}_{T}} t )$$

where C is the capacitance of the capacitor, η is the diode ideality factor, V_T is the thermal voltage and I_s is the reverse saturation current of the diode. The above equation shows that the capacitor voltage after a certain discharge time is related to temperature and as such it may be used as a basis for sensing the temperature of the diode and its surroundings.

For example, assume two similar (matched) diodes, D1 and D2, discharge two capacitors, C1 and C2, with different capacitances. If the initial voltages of the two capacitors is the same and the onset of the discharge is the same, the difference between the capacitor voltages, V_C1 (t) and V_C2 (t), after an initial short time and before the cap voltages becomes comparable with ηV_T, can be calculated from

$$Δ {V}_{C} ( t ) = {V}_{C 1} ( t ) - {V}_{C 2} ( t ) = η {V}_{T} ln ( \frac{{C}_{1}}{{C}_{2}} ) = η \frac{KT}{q} ln ( \frac{{C}_{1}}{{C}_{2}} ) ,$$

which shows that ΔV_C(t) is a voltage that is proportional to absolute temperature T, sometimes known as PTAT.

Another exemplary way for generating a PTAT voltage from a diode-capacitor decaying curve is to discharge a capacitor C by a diode D, with two different discharge times, t1 and t2. If C is charged to an initial voltage larger than the built-in junction potential of D and then being discharge by D for t1 seconds, where t1 is neither too short nor too long that V_C(t) follows (1), then V_C(t_1) can be calculated from

$${V}_{C} ( {t}_{1} ) = - η {V}_{T} ln ( \frac{{I}_{s}}{C η {V}_{T}} {t}_{1} )$$

If a second time, C is charged to the same initial voltage that was charged in the first time, but this time, is being discharged by D for t2 seconds, V_C(t_2) can be calculated from

$${V}_{C} ( {t}_{2} ) = - η {V}_{T} ln ( \frac{{I}_{s}}{C η {V}_{T}} {t}_{2} )$$

Then the difference between V_C(t_1) and V_C(t_2) is a PTAT voltage as follows:

$$Δ {V}_{C} = {V}_{C 1} ( {t}_{1} ) - {V}_{C 2} ( {t}_{2} ) = η {V}_{T} ln ( \frac{{t}_{2}}{{t}_{1}} ) = η \frac{KT}{q} ln ( \frac{{t}_{2}}{{t}_{1}} )$$

Temperature dependence of a capacitor voltage, discharged by a diode, can be used for temperature sensing in FinFET processes which do not incorporate high-quality BJT devices. Especially, the parasitic diode existing between an N-Well and the P-substrate in a bulk or FinFET process is a high-quality diode that can be used for temperature sensing.

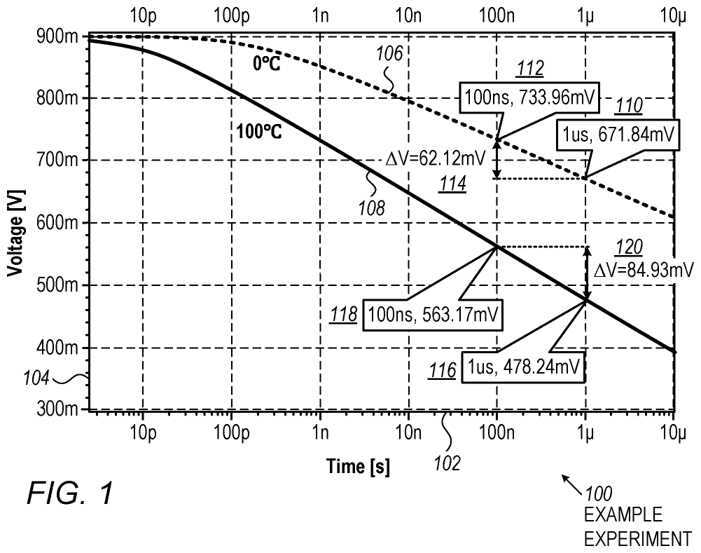

FIG. 1 is an example 100 showing the graphed results of an experiment where a 3 pF capacitor is charged to an initial voltage of 900 mV and then discharged using a diode. The horizontal axis 102 shows time on a logarithmic scale, and the vertical axis 104 shows voltage on a linear scale.

Two discharge curves are shown. Discharge curve 106 represents a OC temperature, and discharge curve 108 represents a 100 C temperature.

Two measurements are taken on the discharge curve 106. Point 110 is taken at 1 us and has a value of 671.84 mV. Point 112 is taken after 100 ns and has a value of 733.96 mV. This gives a voltage difference 114 of 62.12 mV.

Similarly, point 116 is taken at 1 us and has a value of 478.24 mV. Point 118 is taken at 100 ns and has a value of 563.17 mV. A voltage difference 120 is 84.93 mV.

The ratio between the voltage differences 114 and 120 is proportional to the ratio of temperatures (273K for curve 106 and 373K for curve 108). This illustrates how the circuits shown below can be used for measuring temperature.

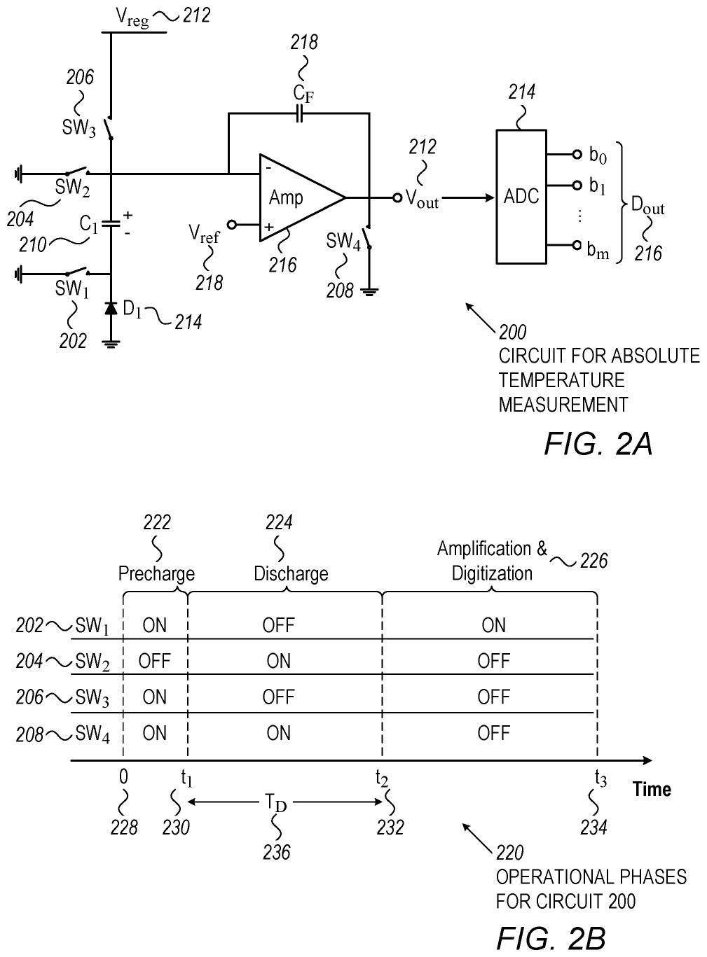

FIG. 2A shows an example circuit 200 illustrating a two-measurement approach for absolute temperature measurement. FIG. 2B illustrates the phases of the measurement sequence.

Circuit 200 operates in three phases 220, according to FIG. 2B. The phases include a precharge phase 222, a discharge phase 224, and an amplification and digitization phase 226.

During the precharge phase 222, switches SW1 202, SW3 206, and SW4 208 are on, while SW2 204 is off. During this phase, the capacitor C1 may be charged to Vreg 212.

During the discharge phase 224, switches SW1 202 and SW3 206 are turned off, while SW2 204 is turned on. During this phase, the positive plate of the capacitor C1 210 is brought to ground, making the negative plate go to −Vreg 212.

The negative voltage −Vreg 212 on the bottom plate of the capacitor C1 210 causes the diode D1 214 to begin discharging the capacitor C1 210. Discharge phase 224 begins at time t1 230 and ends at time t2 232.

At the end of the discharge phase 224, the amplification and digitization phase begins. Such a phase begins when switch SW1 202 is turned on, while the remaining switches SW2 204, SW3 206, and SW4 208 are turned off. The voltage on capacitor C1 210 is amplified by the switched-capacitor amplifier, consisting of AMP 216 and capacitor Cf 218. The output Vout 212 may be digitized by the analog to digital converter 214 to generate a digital output Dout 216.

The voltage of C1 210 at time t2 232 can be calculated from

$${V}_{C} ( {t}_{2} ) = - η {V}_{T} ln ( \frac{{I}_{s}}{{C}_{1} η {V}_{T}} {T}_{D} ) = - η \frac{KT}{q} ln ( \frac{{I}_{s}}{{C}_{1} η {V}_{T}} {T}_{D} )$$

where TD is the length of the discharge phase, which is equal to t2 232 minus t1 230 in FIG. 1B.

V_C(t_2) is sensitive to temperature and can be used for temperature sensing. To do so, the sequence of phases 220 may be repeated, but for a different time period.

The output voltage Vout 212 of the amplifier 216 during the amplification and digitization phase 226 may be calculated from:

$${V}_{out} = \frac{{C}_{1} + {C}_{F}}{{C}_{F}} {V}_{ref} + \frac{{C}_{1}}{{C}_{F}} η {V}_{T} ln ( \frac{{I}_{s}}{{C}_{1} η {V}_{T}} {T}_{D} ) = \frac{{C}_{1} + {C}_{F}}{{C}_{F}} {V}_{ref} + \frac{{C}_{1}}{{C}_{F}} η \frac{KT}{q} ln ( \frac{{I}_{s}}{{C}_{1} η {V}_{T}} {T}_{D} )$$

where Vref is a known reference voltage Vref 218 and can be generated by a reference voltage generation circuit, similar to a bandgap circuit.

The result of the amplification and digitization phase 226 may be contaminated with errors due to non-idealities. These may include offset voltage of the amplifier 216, limited gain of the amplifier 216, and other errors.

By performing a second measurement using a different discharge time and calculating the temperature from the difference of the two measurements, much of the errors inherent in the circuit may be negated.

Using the length of the discharge phase in the first temperature sensing cycle is TD1 and in the second temperature sensing cycle is TD2. Then, the output voltage of Amp 216 at the third phase 226 of the first temperature sensing cycle is

$${V}_{out 1} = \frac{{C}_{1} + {C}_{F}}{{C}_{F}} {V}_{ref} + \frac{{C}_{1}}{{C}_{F}} η {V}_{T} ln ( \frac{{I}_{s}}{{C}_{1} η {V}_{T}} {T}_{D 1} ) = \frac{{C}_{1} + {C}_{F}}{{C}_{F}} {V}_{ref} + \frac{{C}_{1}}{{C}_{F}} η \frac{KT}{q} ln ( \frac{{I}_{s}}{{C}_{1} η {V}_{T}} {T}_{D 1} )$$

and the output voltage Vout 212 of Amp at the third phase of the second temperature sensing cycle is

$${V}_{out 2} = \frac{{C}_{1} + {C}_{F}}{{C}_{F}} {V}_{ref} + \frac{{C}_{1}}{{C}_{F}} η {V}_{T} ln ( \frac{{I}_{s}}{{C}_{1} η {V}_{T}} {T}_{D 2} ) = \frac{{C}_{1} + {C}_{F}}{{C}_{F}} {V}_{ref} + \frac{{C}_{1}}{{C}_{F}} η \frac{KT}{q} ln ( \frac{{I}_{s}}{{C}_{1} η {V}_{T}} {T}_{D 2} )$$

Both of Vout1 and Vout2 are digitized by the ADC 214 and can be stored in two digital registers. If Dout1 is the output of ADC 214 corresponding to Vout1 and Dout2 is the output of the ADC 214, corresponding to Vout2, the difference between Dout1 and Dout2 would be PTAT as follows:

$${D}_{out 1} - {D}_{out 2} ∝ {V}_{out 1} - {V}_{out 2} = η {V}_{T} ln ( \frac{{T}_{D 1}}{{T}_{D 2}} ) = \frac{{C}_{1}}{{C}_{F}} η \frac{KT}{q} ln ( \frac{{T}_{D 1}}{{T}_{D 2}} )$$

The techniques illustrated in FIGS. 2A and 2B substantially minimize errors due to circuit non-idealities due to process variation, offset voltage, limited gain of the amplifier, and other sources of error.

The ratios of C1/Cf and TD1 and TD2 may be selected to optimize the accuracy and performance of the various components. For example, taking long measurements may introduce errors due to current leakage in the various switches. However, the larger the ratio between TD1 and TD2, the greater the PTAT signal. Similarly, the ratio of C1/Cf may be chosen to raise the signal for amplification, but not excessively so to overdrive the amplifier. Similarly, the errors introduced by various components may be selected to be less than the least significant bit of the analog to digital converter.

A designer of such a circuit may have a target accuracy for temperature measurements, and may select the measurement times to reflect the capabilities of the analog to digital converter, the amplifier, and the manufacturing capabilities of the various diodes and capacitors.

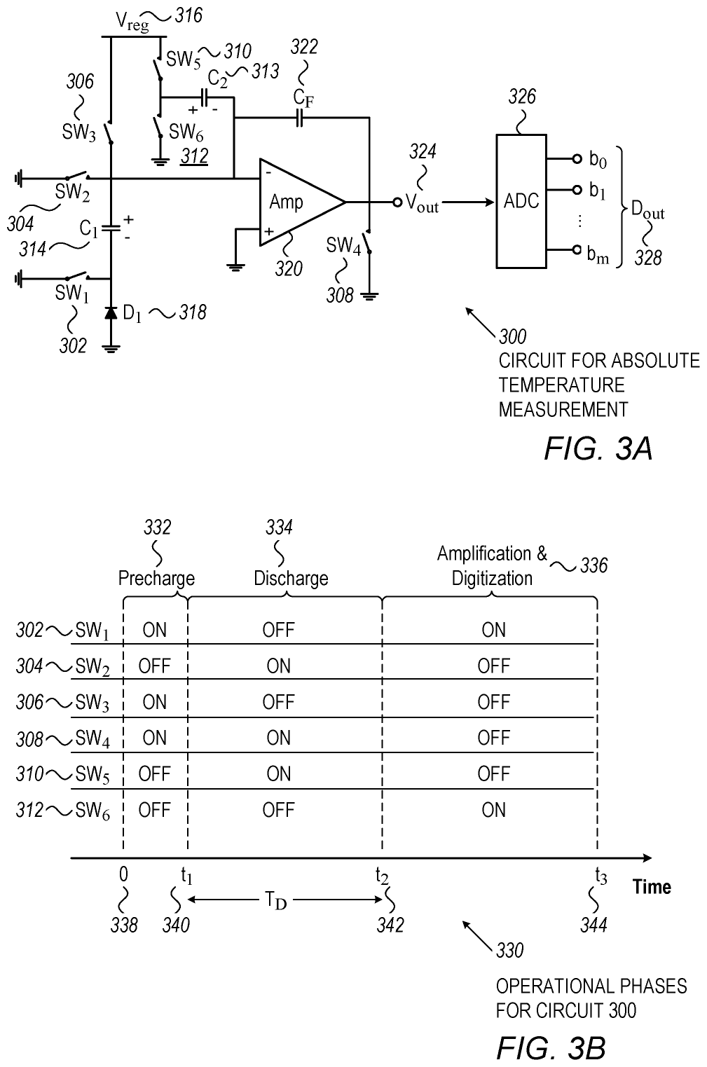

FIGS. 3A and 3B are a schematic diagram of a circuit 300, which is similar to circuit 200, along with a time line of the operational phases 330. However, circuit 300 includes a switched capacitor that adjusts the measured voltage into a range more suitable for amplification and analog-to-digital conversion. In the example of circuit 300, a noninverting amplifier may be shorted to ground, and an additional capacitor may be switched into the circuit.

Switches 302, 304, and 306 may operate to charge the capacitor C1 314 during a precharge phase 332. During the precharge phase 332, switches 302, 306, and 308 may be closed, while switch 304 may be open. During the precharge phase 332, switches 310 and 312 may be open, leaving capacitor C2 313 out of the circuit.

During a discharge phase 334, switches 302, 306, and 312 may be open, while switches 304, 308, and 310 may be closed. Such a configuration may cause the voltage of capacitor 314 on the negative plate to go to −Vreg 316 and the diode 318 to begin discharging the capacitor. The discharge phase 334 may operate from time t1 340 to time t2 342, after which an amplification and digitization phase 336 may begin.

During the amplification and digitization phase 336, switches 302 and 312 may be closed, while the remaining switches may be open. Such a configuration may cause the output of the amplifier 320 to transitions to

$${V}_{out} = \frac{{C}_{2}}{{C}_{F}} {V}_{reg} + \frac{{C}_{1}}{{C}_{F}} η {V}_{T} ln ( \frac{{I}_{s}}{{C}_{1} η {V}_{T}} {T}_{D} ) = \frac{{C}_{2}}{{C}_{F}} {V}_{reg} + \frac{{C}_{2}}{{C}_{F}} η \frac{KT}{q} ln ( \frac{{I}_{s}}{{C}_{1} η {V}_{T}} {T}_{D} )$$

The amplifier 320 may generate a voltage Vout 324, which may be processed by an analog to digital converter 326 to generate a digital output 328. The temperature may be calculated by operating the circuit 300 at two different time intervals and calculating the difference between the measured voltages at each time interval.

The amplifier 320 may generate a voltage Vout 324, which may be processed by an analog-to-digital converter 326 to generate a digital output Dout 328. The temperature may be calculated from Dout 328. Similar to the circuit 200, the circuit 300 can perform two similar temperature measurement cycles, but with two different discharge periods TD1 and TD2. If Dout1 is the output of analog-to-digital converter 326 corresponding to the discharge period TD1 and Dout2 is the output of the analog-to-digital converter 326, corresponding to the discharge period TD2, the difference between Dout1 and Dout2 would be proportional to absolute temperature as follows:

$${D}_{out 1} - {D}_{out 2} ∝ {V}_{out 1} - {V}_{out 2} = η {V}_{T} ln ( \frac{{T}_{D 1}}{{T}_{D 2}} ) = \frac{{C}_{1}}{{C}_{F}} η \frac{KT}{q} ln ( \frac{{T}_{D 1}}{{T}_{D 2}} )$$

Performing two temperature measurement cycles and calculating the temperature from the difference of the results of the two cycles can substantially minimize errors due to circuit non-idealities due to process variation, offset voltage, limited gain of the amplifier, and other sources of error.

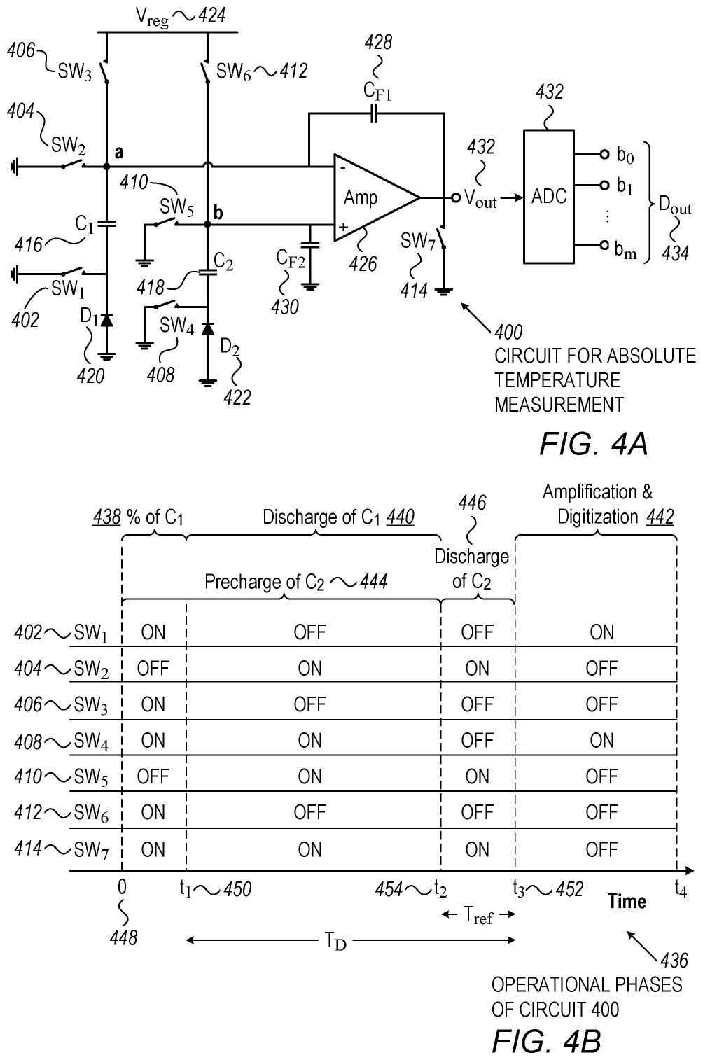

FIGS. 4A and 4B are a schematic diagram of a circuit 400, which is similar to circuit 200, along with a timeline of the operational phases 430. However, circuit 400 uses two capacitors in parallel, which can be used in a differential amplifier to take a temperature measurement in a single pass.

The operation of circuit 400 is such that, in the beginning, each capacitor is charged to the same Vreg 424, but one capacitor is discharged for a longer time than the other. This may be accomplished by beginning the discharge for one capacitor, waiting a period of time, then beginning the discharge for the second capacitor. At one point, both capacitors end the discharge phase, and the amplification and digitization phase 442 may be performed.

Switches 402, 406, 408, 412, and 414 may be closed while switches 404 and 410 may be open. Such a configuration may charge capacitors C1 416 and C2 418 to Vreg 424. This is the precharge phase 438 for C1 416 and the precharge phase 444 for C2 418.

At time t1 450, the discharge phase 440 for C1 416 begins, and switches 402 and 406 are open, while switch 404 is closed. This configuration begins the discharge phase 440, where the diode 420 begins discharging C1 416. The discharge of C1 416 continues until time t3 452.

At time t2 454, the discharge phase 446 for C2 418 begins, and switches 408 and 412 are open while switch 410 is closed. This configuration begins the discharge phase of C2 446, where the diode 422 begins discharging C2 418. The discharge of C2 418 continues until time t3 452.

At time t3 452, the amplification and digitization phase 442 begins. The voltage of the two capacitors C1 416 and C2 418 may be compared by the amplifier 426 to generate a Vout 432, which may be digitized by the analog to digital converter 432 to generate a digital output Dout 434.

The digital output Dout 434 may be proportional to the absolute temperature in Kelvin.

In this circuit, the Vout transitions to

$${V}_{out} = \frac{{C}_{1}}{{C}_{F 1}} η {V}_{T} ln ( \frac{{T}_{D 1}}{{T}_{ref}} ) = \frac{{C}_{1}}{{C}_{F 1}} η \frac{KT}{q} ln ( {N}_{1} )$$

V_out is a signal proportional to proportional to absolute temperature (PTAT).

Circuit 400 may operate with matched diodes D1 420 and D2 422 that drain a set of matched capacitors C1 416 and C2 418. However, there may be some errors that may contaminate the signal, including manufacturing variations and errors related to the amplifier 426, such as offset errors and limited gain.

To substantially minimize these error, one can perform two temperature sensing cycles, in one of which, the length of the discharge phase of C₁ could be equal to T_{D1}=N₁×T_{CK}, where T_CK is the period of the clock signal in the circuit and N1 is a number. In the other sensing cycle, the length of the discharge phase of C₁ can be equal to T_{D2}=N₂×T_{CK}, where N2 is another number, different than N1. In both cycles, the length of the discharge phase of C2 can be equal to TCK. If the digital output of the first temperature sensing cycle is Dₒᵤₜ₁ and the digital output of the second sensing cycle is Dₒᵤₜ₂, then Dₒᵤₜ₁−Dₒᵤₜ₂ is proportional to

$${V}_{out 1} - {V}_{out 2} = \frac{{C}_{1}}{{C}_{F 1}} η {V}_{T} ln ( \frac{{T}_{D 1}}{{T}_{ref}} ) - \frac{{C}_{1}}{{C}_{F 1}} η {V}_{T} ln ( \frac{{T}_{D 2}}{{T}_{ref}} ) = \frac{{C}_{1}}{{C}_{F 1}} η \frac{KT}{q} ln ( \frac{{N}_{1}}{{N}_{2}} )$$

Many of the errors, such as those due to the offset of the amplifier 426, may be substantially the same in both temperature sensing cycles. Therefore, the errors may be substantially minimized by calculating the difference between Dₒᵤₜ₁ and Dₒᵤₜ₂.

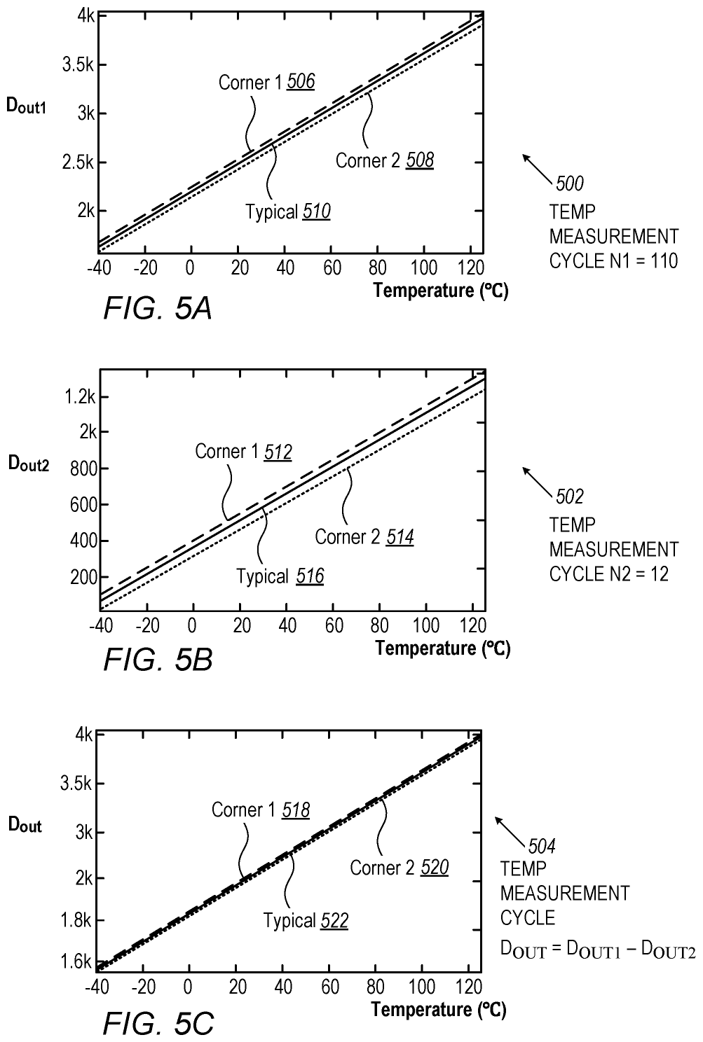

FIGS. 5A, 5B, and 5C illustrate the effectiveness of performing two measurement cycles with two different discharge lengths, then subtracting the results. Each of the FIGS. 5A, 5B, and 5C show plots of temperature on the horizontal axis vs Dout on the vertical axis. FIG. 5A shows a first measurement cycle 500 where N1=110. FIG. 5B shows a second measurement cycle 502 where N2=12. FIG. 5C shows Dout=Dout1−Dout2.

Measurement cycles were analyzed for two PVT corners consisting of: Corner 1: MOS: SS, BJT: FF, Resistor: large, Capacitor, low, VDD: low and Corner 2: MOS: FF, BJT: SS, Resistor: low, Capacitor, high, VDD: high.

FIG. 5A shows the digital output value for the first temperature measurement cycle (N1=110). The temperature sensing error is ±4° C. in cycle 502 where the corner 1 506 and corner 2 508 measurements are shown with a typical value 510.

FIG. 5B shows the digital output value for the second temperature measurement cycle (N2=12). The temperature sensing error is ±6.5° C. in cycle 504 where the output curves for corner 1 512, corner 2 514 and typical models 516. The reason that the error in FIG. 5A is more than that in FIG. 5B is that for the curves in FIG. 5A, the length of discharge phase of C1 is 110 clock cycles, while that in FIG. 5B is 12 clock cycles. This means that the proportional to absolute temperature signal that is generated in FIG. 5A is 1.9 times larger than that in FIG. 5B. However, the magnitude of the errors due to circuit nonidealities is almost the same in both measurements. Therefore, the temperature sensing error is larger in FIG. 5B.

FIG. 5C plots Dout=Dout1−Dout2. The error has reduced substantially because most of the error due circuit nonidealities are the same in the two measurement cycles. These errors may be removed when the results of the two measurement cycles are subtracted. The temperature sensing error is ±1.1° C. in FIG. 5C.

More than two measurements cycles may be performed. For example, in the first one, the discharge phase of C1 can be N1 clock cycles; in the second one, the discharge phase of C1 can be N2 clock cycles and in the third one, the discharge phase of C1 can be N3 clock cycles. In all these temperature sensing cycles, the discharge phase of C2 can be one clock cycle.

Let's call the digital output of the first cycle Dout1, the digital output of the second cycle Dout2 and the digital output of the third cycle Dout3. Then, one can interpret the temperature from Dout1−Dout2, Dout3−Dout2, and Dout1−Dout3, and then find the average of the three temperatures to find a more accurate measurement.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A temperature measuring circuit configured to:
charge a capacitor to a steady state charge voltage during a precharge phase;
discharge said capacitor using a diode during a discharge phase to change voltage of said capacitor to a discharge voltage;
halt said discharge phase and amplify said discharge voltage and measure said discharge voltage using an analog to digital converter during a measurement phase;
a controller configured to:
cause a first precharge phase to be performed;
cause a first discharge phase to be performed for a first time period to generate a first discharge voltage;
cause a first measurement phase to be performed to generate a first measurement; and
calculate a first temperature measurement using said first measurement.

2. The temperature measuring circuit of claim 1, said controller further configured to:
cause a second precharge phase to be performed;
cause a second discharge phase to be performed for a second time period to generate a second discharge voltage;
cause a second measurement phase to be performed to generate a second measurement;
calculate a second temperature measurement based on said first measurement and said second measurement.

3. The temperature measuring circuit of claim 1 implemented as part of an integrated circuit.

4. The temperature measuring circuit of claim 1, said second time period being at least ten times said first time period.

5. The temperature measuring circuit of claim 1, said temperature measurement being calculated by a difference in said first measurement and said second measurement.

6. The temperature measuring circuit of claim 1 configured to operate continuously.

7. The temperature measuring circuit of claim 1 configured to operate on demand.

8. The temperature measuring circuit of claim 1 further comprising:
a second capacitor configured to be charged to said steady state voltage in said second precharge phase;
a second diode configured to discharge said second capacitor in said second discharge phase to generate said second discharge voltage.

9. The temperature measuring circuit of claim 8, said temperature measurement being calculated in part based on a differential signal between said first discharge voltage and said second discharge voltage.

10. The temperature measuring circuit of claim 9, said first discharge phase and said second discharge phase being performed at least in part simultaneously.

11. The temperature measuring circuit of claim 8 wherein said circuit is calibrated by adjusting a length of at least one of said discharge phases.

12. The temperature measuring circuit of claim 1 comprising a switched capacitor amplifier.

13. The temperature measuring circuit of claim 1, said first time period and said second time period are fixed time periods.

14. The temperature measuring circuit of claim 1, at least one of said first time period and said second time periods are adjustable time periods.

15. The temperature measuring circuit of claim 1, said diode being a PN junction between a silicon substrate and an N-type well.

16. The temperature measuring circuit of claim 1, wherein amplification of said discharge voltage is performed using a switched-capacitor amplifier.

17. The temperature measuring circuit of claim 1 wherein said circuit is calibrated by adjusting the length of said discharge phase.

18. A method for measuring temperature on a device, said method comprising:
charging a first capacitor to a steady state charge voltage during a first precharge phase;
discharging said first capacitor using a first diode during a first discharge phase to change voltage of said first capacitor to a first discharge voltage;
halt said first discharge phase and amplify said first discharge voltage and measure said first discharge voltage using an analog to digital converter during a first measurement phase;
charging a second capacitor to a steady state charge voltage during a second precharge phase;
discharging said second capacitor using a second diode during a second discharge phase to change voltage of said second capacitor to a second discharge voltage;
halt said second discharge phase and amplify said second discharge voltage and measure said second discharge voltage using an analog to digital converter during a second measurement determining a temperature based on a difference between said first discharge voltage and said second discharge voltage.

19. The method of claim 18, said first capacitor and said second capacitor are the same capacitor.

20. The method of claim 19, said first diode and said second diode are the same diode.

21. The method of claim 21 being performed when all circuit components are on the same integrated circuit.

22. The method of claim 18 further comprising:
charging said second capacitor to a steady state charge voltage during a third precharge phase;
discharging said second capacitor using said second diode during a third discharge phase to change voltage of said second capacitor to a third discharge voltage;
halt said third discharge phase and amplify said third discharge voltage and measure said third discharge voltage using said analog to digital converter during a third measurement phase;
determining a second temperature based on at least said first discharge voltage, said second discharge voltage, and said third discharge voltage.

24. The method of claim 18, said first diode and said second diode are matched diodes.

25. The method of claim 18, said first capacitor and said second capacitor are matched capacitors.

26. The method of claim 18, amplification of said discharge voltages being performed using a differential switched-capacitor amplifier.
